(19) United States
(12) Patent Application Publication
(10) Pub. No.: US 2012/0221361 A1
(43) Pub. Date: Aug. 30, 2012

(54) NETWORKING TERMINAL DEVICE FOR SUPPORTING BUSINESS IN A PUBLIC SPACE, AND SUPPORT SYSTEM FOR THE INSURANCE BUSINESS USING SAME

(75) Inventors: Jin Soo Park, Gunpo-si (KR); Soo Yeol Yang, Incheon (KR); Mun Kyu Choi, Seoul (KR); Ji Whan Yoon, Paju-si (KR); Hee Jong Jung, Seoul (KR)

(73) Assignee: INPION CONSULTING CO., LTD., Seoul (KR)

(21) Appl. No.: 13/505,843

(22) PCT Filed: Nov. 4, 2010
(86) PCT No.: PCT/KR2010/007731

§ 371 Date: May 3, 2012

(30) Foreign Application Priority Data
Nov. 4, 2009 (KR) 10-2009-0106099
Nov. 17, 2009 (KR) 10-2009-0110588

(51) Int. Cl. G06Q 40/00; G06Q 20/18

(52) U.S. Cl. 705/4; 705/17

(57) ABSTRACT

The present invention relates to a networking terminal device for use in a public space, which accesses a server in connection with a communication cable installed at the public space and includes a screen and an input unit. the networking terminal device includes: a scanning element for scanning a document and an identification card to generate an electronic file; an authentication element for authenticating a user; a real-time communication element accessing the server for transmitting a file, which is generated by the scanning element and/or the authentication element, to the server; and an application element for executing a supporting business selected according to a predetermined process, wherein the elements are embedded in a housing and operated according to the control of a control unit in the housing.

### TECHNICAL FIELD

The present invention relates to a networking terminal device and a business supporting system using the same.

### BACKGROUND ART

“Representative examples of a networking terminal device in a public space include an automated teller machine (ATM) of a bank, and a certificate issuing device of an administrative agency or hospital. Additionally, KIOSKs for providing predetermined information are extensively distributed in public spaces. Such a device performs a desired function according to a predetermined process set by accessing a network server. The device accesses a system through an exclusive communication line and has a user interface. A user of the device searches for and reads information through a user interface and transmits a request through a predetermined input action. An output unit of the device mainly includes a monitor, but may further include a predetermined printer in the case of a certificate issuing device or ATM.

The above devices are only terminals dependent on a network, and perform only limited functions such as simple input/output functions. Accordingly, since the user interfaces of typical devices are extremely limited, their users have passive roles in a system.

Typical devices only use information that are established in advance by a database and have difficulties in actively creating information or setting an interactive relationship between device users and systems.

There are a plurality of unspecified users in a public space. Moreover, public spaces such as administrative agencies, hospitals, banks, convenient stores, and subway stations are adjacent to residential areas. Due to such location-related features, a networking terminal device in a public space has excellent user accessibility. That is, a user may easily access the networking terminal device and use it conveniently. Nevertheless, due to a poor user interface that a typical device has and its dependent role in a system, the typical device performs very limited functions within an entire network.

The inventors of the present invention have worked on a new networking terminal device that resolves the above basic limitations and have also researched a field to which a new terminal device is industrially applicable. Here, from among typical business systems, insurance business systems have especially been addressed. The reason is that the spirit of a new technology disclosed in this specification is easily understood and also, the new technology may be easily industrialized, by analyzing the limitations of a typical insurance business system.

In relation to an insurance business, there are a plurality of elements. The elements may include a customer who signs an insurance product, a contractor (or a representative), a Financial Consultant (FC), an office, and an insurance company. Furthermore, the insurance company includes a plurality of human resources such as a manager and counselors. If the elements and human resources are classified simply, they may be divided into two, i.e., customers and companies.

The ultimate goal that a customer wants from an insurance contract is to receive an insurance payment. For this, necessary administrative procedures need to be performed. First, requirements for claiming an insurance payment need to be satisfied. Next, an application needs to be submitted according to a predetermined format in a predetermine place, and in the case of an accident insurance claim, an insurance payment is finally paid after insurance payment evaluation. In order to perform the above procedures, a customer prepares documents needed, and fills and signs application documents. Then, the documents needed are sent to headquarters through an officer or FC, by means of a method such as by fax, mail, and e-file transmission. An insurance company examines the required documents, stores records and documents, and transfers an insurance payment to a customer's account.

However, a typical insurance coverage payment method has limitations as follows. First, the typical limitations relating to customers are as follows.

1. 1. Difficulty of accessing a window; in order to claim an insurance payment, as a rule, a claimant visits a branch of an insurance company, fills out an application, and submits the documents needed. However, there is lack of branches in local small cities, rural areas, or remote areas. In this case, if an FC of an insurance company cannot personally visit a claimant, the claimant needs to inconveniently visit a branch in an adjacent area. Even if there is a branch in a corresponding area, related business processing may often be impossible, or it may be inconvenient for the claimant to wait for a long line. Due to these inconveniences, a customer may fill out an application, and send the documents needed by post.

2. 2. Difficulty of filling out an application; in order to receive an insurance payment, an application needs to be filled out. However, since documents related to the insurance need to be filled out according to strictly defined procedures, in general, it is difficult for a customer to fill out the documents alone. It is the most desirable that an expert, that is right beside a customer, explains the documents to the customer, and looks at them together with the customer. However, if no export is available, as a rule, a customer must listen to the explanation from a counselor of an insurance company by telephone, or must read a user guide on the website of an insurance company, in order to fill out an application.

3. Inconvenience of submitting documents; it is required that a customer necessarily prepares and submits documenting evidence when filing an accident insurance claim in an application for an insurance payment. The documenting evidence may be submitted by fax, post, and e-mail. However, if the documenting evidence transmitted by the above medium is incorrect or insufficient, the customer should submit them again. Additionally, a customer may personally visit a branch of an insurance company and submit documenting evidence at a customer window, but it is still difficult to submit the documenting evidence in an area having no branches.

4. 4. Waste of time; according to a typical insurance coverage payment method, in the case of a local small city, rural area, or remote area having no branches of an insurance company, it takes a lot of time to apply for an application.

In relation to an insurance claim for payment, the above typical limitations from the customer's perspective may mostly be resolved by a service in which an FC of an insurance company personally visits the customer's home and helps file an insurance claim for payment. However, not all insurance companies provide such a service. Moreover, in order to receive such a service, a customer needs to make an appointment first, but it is still cumbersome for the customer to prepare all documenting evidence by the appointment. Moreover, since considerable human resources are required for that service, it may be disadvantageous for an insurance company to offer the service.

In addition, in relation to insurance coverage payment business, it is difficult for an insurance company to provide an active service relating to the demands of customers who reside in an area having no branches such as a local small city, rural area, and remote area. Further, it is not easy for an insurance company to open a branch having a customer window in an area where a small number of customers reside, by investing in material and human resources. That is, customer service for an insurance company has such regional limitations.

A predetermined examination is required, and also signed applications and documenting evidence is received from a customer, in order for an insurance company to pay insurance coverage. Also, an insurance company is required to retain those documents. Although paper documents were retained in the past, they are now converted into electronic documents and kept today in a systematic and permanent storage format. According to the trend, much material and human resources are invested for the business of digitalizing various documents. Accordingly, when documents necessary for paying an insurance coverage are received from a customer by fax, mail, and in person, an insurance company converts the received documents into electronic documents. Representative examples of such documents include document that prove identification, signed applications, powers of attorney, documenting evidence of accidents, and expenditure vouchers of customers.

Although the above limitations are mainly due to the regions and locations where customers reside, in some respects, they may be caused by the inherent limitations of a typical off-line system. The typical off-line system causes inconvenience to a customer, and human and material management burden to an insurance company.

Referring to the terminal device again, due to another limitation of a typical networking terminal device, legal action may not be taken by using it. Some financial businesses, insurance businesses, banking businesses, and other administrative businesses may require examination, and legal action relating to these businesses may require the implementation of prescribed procedures, submission of documents, and a signature of a petitioning applicant. If such requirements are not satisfied, a corresponding legal action may not be held valid. However, since a typical device has a poor user interface, actions that a user can perform by using it are limited to simple network access and information inquiry and change. Due to such limitations, it is impossible to perform a legal action itself by using a terminal device in a public space.

The inventors of the present invention have overcome the typical technical limitations in the results of research efforts over a long time, and thus, have completed the present invention.

### DISCLOSURE OF THE INVENTION

### Technical Problem

In order to resolve the above limitations, the first aspect of the present invention provides a new networking terminal device for taking a legal action by a user through access to a network in a public space. The legal action refers to an action that completes a predetermined application requirement as a user is authenticated in real time and predetermined documents are submitted according to predetermined requirements. Additionally, according to another object of the present invention, a user interface is to be expanded in terms of hardware and software in order to take a legal action by using a terminal device in a public space. According to such an expansion of the user interface, a terminal technically satisfies a legal action requirement, and as a result, enhances a user's convenience.

Additionally, according to another object of the first aspect of the present invention, simplification and effectiveness of an administrative business is to be enhanced when an application action of a user is processed using a terminal device. That is, a typical offline business is digitalized.

Additionally, according to the second aspect, more enhanced convenience is provided to a customer in relation to a claim application for payment by using the terminal device suggested in the first aspect. Especially, the present invention provides a convenience that does no exist before to customers who reside in an area having no branch (hereinafter, a branch having a customer window) of an insurance company. Additionally, it is intended to provide also an improved convenience to customers who reside in an area having a branch of an insurance company. Customer's convenience achieved by a new system or new method of the present invention is directly related to the revenue of an insurance company. The reason is that the convenience means customer service improvement of an insurance company. A goal of the present invention related to customers may be specified as follows.

1. Resolution of region and place limitations; it is practically impossible for an insurance company to establish branches in all areas, as huge investment needs to be made and there is no return on investment. However, in relation to at least a claim application for payment, provided is a method that substantially has the same effect as having branches in most areas. For this, special attention is made on a data communication network that is already established in all areas. Moreover, ten branches in a certain area unit may far more improve a customer's convenience than one branch. The reason is that more branches greatly improve adjacency to an insurance company. A goal of the present invention is to greatly improve such adjacency in relation to a claim application for payment.

2. Convenience of submitting an application and documentary evidences; as mentioned above, many customers experience difficulties in filling out a claim application for payment and submitting a documentary evidence. A goal of the present invention systematically realizes an environment in which an expert, being right beside a customer, helps him/her one by one, looking at documents together. Additionally, a new system that the present invention pursues means a system that is available to simply process customer related procedures.

Moreover, in relation to material and human effectiveness of an insurance company that the present invention of the second aspect provides, detailed goals of the present invention are described as follows.

1. By effectively resolving typical region and place limitations related to a claim application for payment, provided are a system and method for enhancing customer service. Moreover, through this, the present invention has a goal to improve a consulting business related to a claim application for payment, save a customer window business, and enhance efficiency of material and human resources. For this, the present invention aims for an unattended system ultimately.

2. The present invention automatically digitalizes various documentary evidences, which are submitted for a claim application for payment, during an application stage, and thus realizes a system for saving material and human resources invested on a typical electronic documentation business.

Moreover, other goals not specified by the present invention will be additionally considered within the scope that is easily deduced from detailed description below and its effects.

### Technical Solution

Embodiments of the present invention provide a networking terminal device in a public space, which accesses a server in connection with a communication cable installed at the public space and includes a screen and an input unit, the networking terminal device including:

a scanning element for scanning a document and an identification card to generate an electronic file;

an authentication element for authenticating a user;

a real-time communication element accessing the server for transmitting a file, which is generated by the scanning element and/or the authentication element, to the server the server; and

an application element for executing a supporting business selected according to a predetermined process,

wherein the elements are embedded in a housing, and operated according to the control of a control unit in the housing.

In other embodiments of the present invention, a system for supporting an insurance business of an unattended terminal includes:

an application server of an insurance company;

P (P is an integer greater than 1) counselor terminals connected to an internal network of the application server of the insurance company; and

N (N is an integer greater than 1) number of customer-only unattended terminals being disposed in different remote physical spaces and being 1:1 mapped to the counselor terminals for communication,

wherein each of the customer-only unattended terminals includes: an element for a real-time video call and/or voice call with the counselor terminal; an element for scanning a document that is to be transmitted to the counselor terminal; and an application element programmed to process a predetermined insurance payment request process, wherein an insurance payment request is transmitted to the counselor terminal in real time.

In still other embodiments of the present invention, there is provided a method of using a system for supporting an insurance business of an unattended terminal, the method including:

connecting a customer-only unattended terminal located in a different remote physical space to an insurance company server;

switching a plurality of counselor terminals by the insurance company server so as to tunnel a 1:1 communication channel between the customer-only unattended terminal and the counselor terminal;

scanning user authentication information by the customer-only unattended terminal;

confirming the scanned user authentication information by the counselor terminal;

performing an insurance payment request procedure while the customer-only unattended terminal receives a remote communication support of the counselor terminal in real time;

if submitting a documentary evidence is required, scanning and transmitting the documentary evidence by the customer-only unattended terminal; and

inputting an electronic signature by the customer-only unattended terminal and confirming the electronic signature by the counselor terminal.

### Advantageous Effects

By the above technical solution, there are advantages in freely taking a predetermined legal action through access to a system when a user uses the networking terminal device of the present invention installed in a public space such as an administrative agency.

In the networking terminal device of the present invention, since a user interface is expanded in terms of hardware and software, multiple authentication is possible, and documents needed are submitted immediately.

The above advantages bring effects that drastically reduce typically-existing place limitations and time consumption ultimately when a user takes a predetermined legal action.

Moreover, according to another effect of the present invention, since documents needed for a business are automatically scanned and stored as data through the networking terminal device of the present invention, material and human resources are saved in aspects of electronic document generation and record keeping businesses.

When an insurance business supporting system is established using the networking terminal device of the present invention having the above advantages and effects, the following clear effects are obtained.

1. In relation to a claim application for payment, typically-existing region and place limitations are mostly resolved by the present invention. Customers who reside in an area having no branch of an insurance company may file an insurance claim conveniently and promptly by using an unattended terminal installed in an administrative agency, convenient store, and hospital. Moreover, since a prompt application is possible by using the unattended terminal, the time for visiting a customer window and waiting for service may be saved.

2. Since a customer uses an unattended terminal to receive a real time guide from a counselor (online-helper) of an insurance company, there is no difficulty in operating the unattended terminal. Moreover, since a customer fills out an electronic application with the counselor guide and submits documentary evidences in real time through an unattended terminal, the convenience of a claim application for payment and documentary evidence submission are greatly improved.

3. In terms of an insurance company, advantages of the present invention are as follows. By effectively resolving typical region and place limitations related to a claim application for payment, a customer service is enhanced. Moreover, in relation to a consulting business of an insurance company related to a claim application for payment, branch open, or a receipt business through a branch's customer window, a large part of material and human resources are saved through the networking terminal device of the present invention.

4. Moreover, many resources of an insurance company are invested on electronic document generation and record keeping businesses, the system of the present invention for digitalizing and storing various documents related to a claim application for payment brings vary large effects. These effects enhance material and human efficiency of an insurance company system.

In addition, even if certain effects are not specifically mentioned in the specification of the present invention, potential effects expected by the technical feature of the present invention are treated as being specified in the specification.

### BRIEF DESCRIPTION OF THE DRAWINGS

FIG. 1 is an architectural view illustrating main modules of application elements of a networking terminal device 100 of the present invention.

FIG. 2 is a view illustrating a hardware configuration module of a networking terminal device 100 of the present invention.

FIGS. 3 and 4 are views illustrating a housing configuration example of a networking terminal device 100 of the present invention.

FIG. 5 is a view illustrating a system configuration example that a networking terminal device 100 of the present invention belongs.

FIG. 6 is a more specified view of FIG. 5.

FIG. 7 is a schematic flowchart illustrating an entire configuration of a real-time supporting process relating to an insurance claim for payment according to an embodiment of the present invention.

FIG. 8 is a flowchart illustrating a user authentication process of a supporting business process executed by an application element of a networking terminal device of the present invention.

FIG. 9 is a view illustrating an initial screen configuration example of a networking terminal device.

FIG. 10 is a view illustrating a screen configuration example of a networking terminal device when an identification card is inserted into a scanner for the insured identification.

FIG. 11 is a view illustrating a screen configuration example of a networking terminal device when an identification card is inserted into a scanner for the representative identification.

FIG. 12 is a view illustrating a screen configuration example of a networking terminal device when a real business processing process starts according to a process of the present invention after the user authentication is completed.

FIG. 13 is a view illustrating a screen configuration example of a networking terminal device when a signature of a user is required after an insurance payment request procedure is performed.

FIG. 14 is a view illustrating a screen configuration example of a networking terminal device when a receipt is printed after an insurance payment request procedure is completed.

FIG. 15 is a view illustrating a screen configuration example of a networking terminal device when a documentary evidence is inserted into scanner during an insurance payment request procedure.

FIGS. 16 and 17 are views illustrating a screen configuration for a helper to connect with e-Insubanking system.

FIG. 18 is a view illustrating a screen configuration example of a counselor terminal, which displays a real-time captured user image and information of a networking terminal device when the counselor terminal are and the networking terminal device are in 1:1 communication.

FIG. 19 is a view illustrating a scan view pop up on a screen of a counselor terminal.

FIG. 20 is a view of when a screen of a networking terminal device of FIG. 12 is shared by a counselor terminal.

FIG. 21 is a view illustrating a screen configuration example of when a signature is displayed on a screen of a counselor after a networking terminal device inputs the signature.

### MODE FOR CARRYING OUT THE INVENTION

Hereinafter, specific contents on embodiments of the present invention will be described with reference to the accompanying drawings. Moreover, detailed descriptions related to well-known functions or configurations will be ruled out in order not to unnecessarily obscure subject matters of the present invention.

<A First Aspect of the Present Invention>

A networking terminal device 100 of the present invention includes application elements for executing a supporting business selected according to a predetermined process. This application elements may be program elements installed in advance in the networking terminal device 100, but may include a hardware configuration for executing a program.

The application elements of the present invention provide businesses for supporting a guide and receipt in real time via a network. Of supporting businesses of the present invention, “an insurance claim” business will be exemplarily described, for convenience, according to an embodiment below.

However, if a business requires interactive real-time conversation, a real-time authentication procedure, and application submission, their processes may be included in the application elements of the present invention. Accordingly, the application elements of the present invention are understood as elements for taking a formal legal action through a networking terminal device installed in a public space.

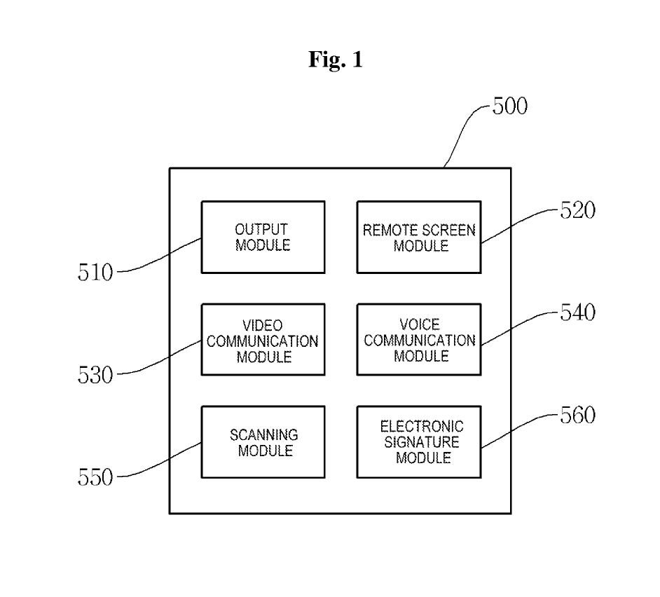

First, main modules for executing a business process, i.e., the application elements of the present invention, are shown in a conceptual view of FIG. 1.

An output module 510 transmits an insurance claim request through the networking terminal device 100, and then outputs a receipt for a corresponding request. A remote screen module 520 is a service module for sharing a screen of the networking terminal device 100 with a remote agent terminal for remote support. A video communication module is a service module for supporting a video communication using a web cam between the networking terminal device 100 and a user of an agent terminal. A voice communication module 540 is a service module for supporting a bi-directional communication through voice chatting. A scanning module is a service module for scanning an identification card and documentary evidence that are to be transmitted through the networking terminal device 100, and transmitting scanned image information to the agent terminal. An electronic signature module 560 transmits electronic signature information inputted from the networking terminal device 100, i.e., a signature or finger print recognition information of a user of the networking terminal device 100 inputted through a sign pad.

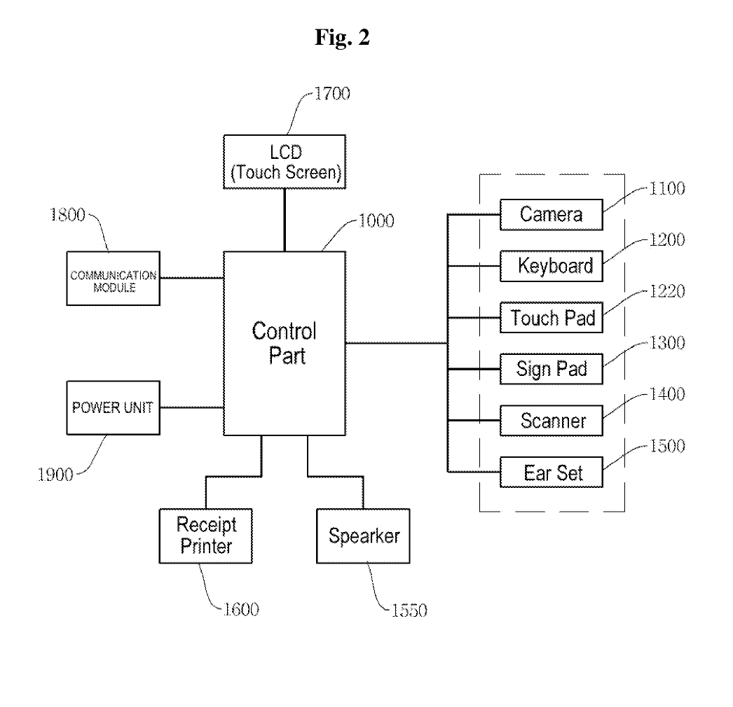

FIG. 2 is a view illustrating a hardware configuration of the customer-only networking terminal device 100 of the present invention by each functional module. The networking terminal device 100 includes an input unit, an output unit, a communication module, a power unit for supplying power thereto, and an LCD having both input and output functions.

The input unit includes a camera 1100, a keyboard 1200, a touch pad 1220, a sign pad 1300, and scanner 1400, and an ear set 1500. The camera 1100 may include a built-in mike, and have an automatic Face-Tracking function. The sign pad 1300 may be a standard pressure-type sign pad. Additionally, according to another embodiment, a finger print recognizer (not shown) may be included instead of or in addition to the sign pad. The scanner 1400 scans a plastic identification card up to A4 size with a sheet-fed type, and may have a resolution of standard 200 dpi (Max 1200 dpi).

The output unit includes a printer 1600 for printing a receipt and a speaker 1550. A supporting paper of the printer 600 may be printed with a 2-3 inch Thermal Line and support a speed of 250 mm/sec. A printer specification may be changed in order to fit an output format of a receipt. The LCD 1700 may serve as an input/output unit consisting of a touch screen. Moreover, the control unit 1000 may be controlled by a PC.

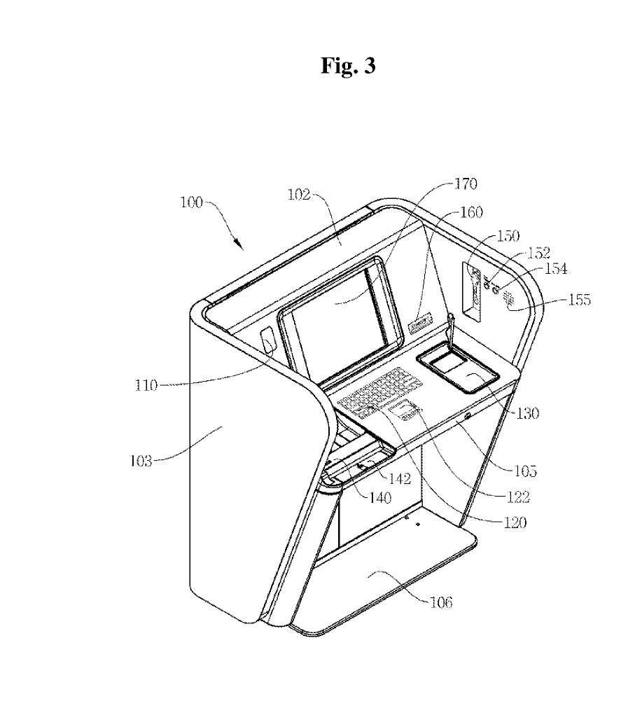

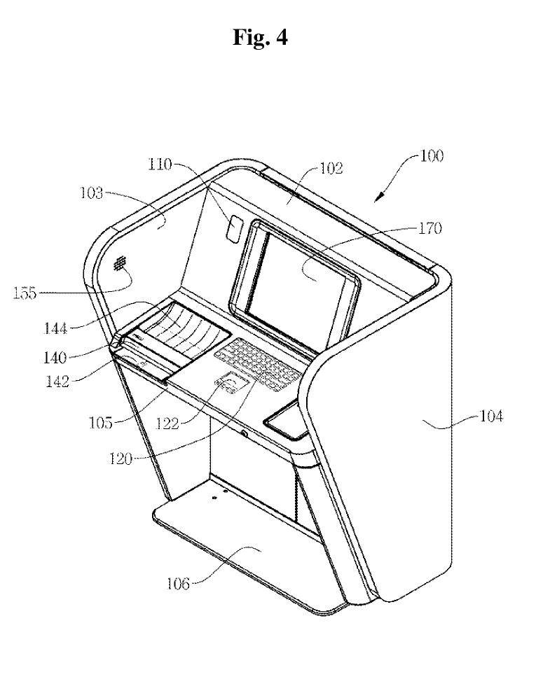

FIGS. 3 and 4 are views illustrating a housing configuration example of the customer-only networking terminal device 100. The housing of the networking terminal device 100 includes a front part 102, side wing parts 103 and 104, an input unit guiding part 105, a bottom part (not shown), and a user position guiding part 106. The elements of FIG. 2 are built in the housing of FIGS. 3 and 4.

Preferably, a user may use a terminal device of the present invention, sitting on a chair. Accordingly, the height of the input unit guiding part 105 of the housing may be set to the height at which a user sit on a chair and uses a terminal device of the present invention. The front part 102 is somewhat slanted toward the rear, and is bending toward the front as sliding downward. The input unit guiding part 105 is formed as protruding from the bending starting point. The size of the touch screen 170 built in the front part 102 may be 15 inches to 23 inches, and more preferably may be 17 inches. If the screen is too small, it is difficult to use, and if the screen is too large, the entire size of the housing becomes larger.

The LCD of the touch screen 170 is built in the middle of the front part 102 of the housing, and the camera 110 and the printing paper outlet of the receipt printer 160 are installed at the upper left and the right, respectively. The camera 110 captures an image of a user when the user uses the networking terminal device of the present invention, and transmits the image to another terminal (e.g., a counselor terminal at the server side) in real time in connection with a network.

Various kinds of input units used in the present invention are built in the input unit guiding part 105 protruding toward the front. A user inputs a key by manipulating the keyboard 120, and moves a mouse cursor by using the touch pad 122.

The sign pad 130 built in at the right of the input unit guiding part 105 may be used when an electronic signature is inputted. According to another embodiment, a finger print recognizer may replace the sign pad 130, and according to another embodiment, the finger print recognizer and the sign pad 130 may be installed together. These units serve to finally complete a legal action or legally authenticate a user. When a public space where the networking terminal device 100 of the present invention is installed is an administrative agency, the finger print information obtained by a finger print recognizer built in the terminal device is to be compared with that obtained from a database of the administrative agency. Therefore, more efficient official authentication becomes possible. In the most preferred embodiment, the terminal device of the present invention may access a network of an administrative agency in a secure state.

The scanner 140 may be installed at the left of the input unit guiding part 105. The scanner 140 scans documentary evidences such as an identification card, a power of attorney, and a medical certificate. Once a corresponding document or identification card is inserted into an input slot 142, the scanner 140 starts to scan and discharges it to an output slot 144.

The side wing parts 103 and 104 of the housing block the gazes of others, and elements such as the ear set 150, function selection buttons 152 and 154, and the speaker 155 may be built in the side wing parts 103 and 104. A user may use the ear set 150 by pressing the function selection button 152, and may make a real-time conversation through the speaker 155 by pressing the function selection button 154. At this point, the other side is a counselor terminal connected to a network.

<A Second Aspect of the Present Invention>

The configuration of the networking terminal device 100 was described in detail above. Now, a network that the terminal device 100 accesses will be examined, and roles of the terminal device 100 in a network will be described in more detail.

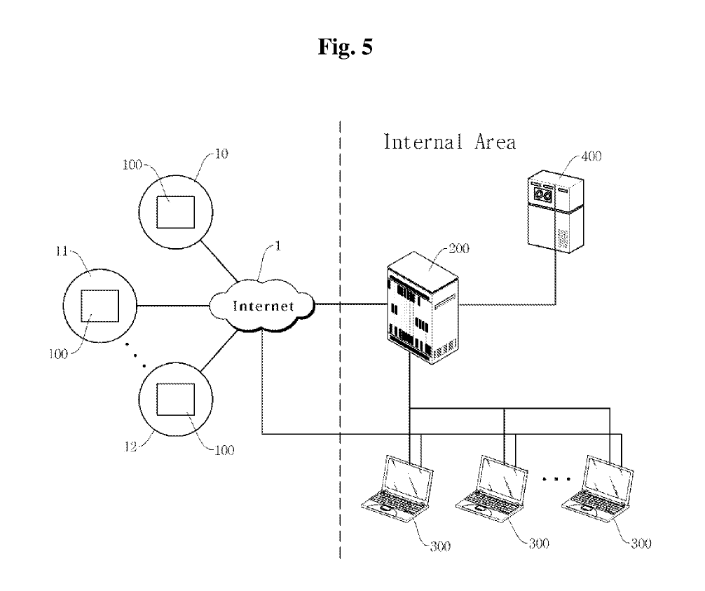

Firstly, FIG. 5 is a schematic view illustrating a network system configuration that the terminal device belongs. In this system, a plurality of networking terminal devices 100 in physical spaces 10, 11, and 12 remotely spaced from each other, an application server 200 of an insurance company, and a plurality of counselor terminals 300 are mutually networked. The system is divided into an internal network and an external network on the basis of the fire walls 201 and 202, and through internet, the plurality of networking terminal devices 100 may access the application server 200 of the insurance company in the internal network. The networking terminal device 100 is customer-only, and another terminal 300 connected to a network is a terminal of a counselor employed by the insurance company.

The plurality of networking terminal devices 100 are spaced from each other. Preferably, they may be placed in remotely spaced different regions. Here, the different regions refer to regions having different addresses. The spaced distance may be a few km to tens of km, but the present invention is not limited thereto. If a country has larger regions, the spaced distance may be greater, and if terminals are intensively installed in a large city, the spaced distance may be smaller. In some cases, a plurality of terminals may be installed in the same building. In this case, the terminals are spaced from each other within a short distance of about 1 km. However, the plurality of networking terminal devices in the same building may be regarded as a single networking terminal device in terms of an entire system. The reason is that a main purpose of the system according to the present invention is to integrate the N (N is an integer greater than 10) number of networking terminal devices in different regions into one system.

That is, the physical spaces 10, 11, and 12 are remotely spaced from each other, but the plurality of networking terminal devices 100 in the physical spaces 10, 11, and 12 serve as independent clients in relation to the system server. Here, the physical spaces 10, 11, and 12 refer to arbitrary places where users easily access in the building, and also, a data communication line in the building, for example, an internet line, is connected to the networking terminal device 100.

The physical spaces 10, 11, and 12 having the networking terminal devices 100 have a very important meaning as a system element. The reason is that the purpose of the system is to secure convenience and speed during an insurance claim (the term “claim” has the same meaning as the term “application” in this specification). Moreover, the purpose is also applied to a region having no customer window of an insurance company for an easy insurance claim for payment. The physical spaces 10, 11, and 12 may be placed in an internal network or heterogeneous network of an insurance company, and thus, there are various embodiments relating to the heterogeneous network.

In a first embodiment, a heterogeneous network may be a network of an administrative agency. Since the network of an administrative agency covers all regions, people may easily access the network. There may be a minimum unit (for example, a community service center) of an administrative agency even in a region having no branch of an insurance company. The physical spaces 10, 11, and 12 may be in the building of the administrative agency. According to this embodiment, the networking terminal device 100 is placed in the building of the administrative agency, and accesses the network via a communication line installed in the building.

A customer visits an administrative agency, and files an insurance claim for payment by using the networking terminal device 100 therein in connection with the application server 200 of the insurance company. Here, the administrative agency may refer to a national agency providing public administrative services or a local government agency. Each country has different organizational systems, but includes an administrative agency near the living area of people in order to perform administrative businesses of a public purpose, and similar organizations thereto.

In a second embodiment, the heterogeneous network may be a network of a convenient store, and thus, the physical spaces 10, 11, and 12 may refer to the inside of the convenient store. As ATMs are installed in most convenient stores, the networking terminal device 100 is installed in a convenient store, so that it accesses the application server 200 of the insurance company.

In a third embodiment, the physical spaces 10, 11, and 12 may be a hospital. Since documents such as medical certificates are issued from a hospital, it is possible to file an insurance claim for payment in the quickest way. A customer may visit an administrative agency, and file an insurance claim for payment by using the networking terminal device 100 therein in connection with the application server 200 of the insurance company. At this point, types of claimed insurance payment are typically an accident insurance payment.

The physical space of the present invention is not limited to the types of a heterogeneous network. If a place is internet-accessible and easily accessed by customers, it is included in the physical space of the present invention. Its representative examples include banks, securities companies, and stations of traffic facilities. However, there may be difficulties in installation contract and management.

Moreover, the physical spaces 10, 11, and 12 may be a branch of an insurance company. This means that the internal network of the insurance is used. Since the internal network is used in this embodiment, management becomes easy, and efficiency becomes improved by removing or reducing the number of customer windows of a branch.

Referring to FIG. 5 again, the networking terminal device 100 in remotely-spaced different physical spaces accesses the application server 200 of the insurance company via an internet 1. Moreover, the internal network of the insurance company includes a plurality of counselor terminals 300, and each counselor terminal 300 maintains an access to the application server 200 of the insurance company. Once the networking terminal device 100 accesses the application server 200 of the insurance company, the application server 200 delivers the ID and IP address of the networking terminal device 100 to a plurality of counselor terminals 300 logged in by a switching system in order for polling. If the counselor terminal 300 is specified, its ID is automatically obtained, so that a TCP/IP 1:1 communication starts between the networking terminal device 100 and the counselor terminal 300. Through this communication, the counselor terminal 300 remotely supports the networking terminal device 100 in real time.

A user of the networking terminal device 100 accesses the application server 200 of the insurance company in order to generate an information query and a claim event for payment. The counselor terminal 300 remotely supports the networking terminal device 100, and accesses the application server 200 of the insurance company in order to generate an information query and a change event. The application server 200 of the insurance company accesses a Legacy 400 in order to request information. The Legacy 400 is an information system that an insurance company owns for processing insurance businesses such as contract, payment, deposit, preservation, and customer management.

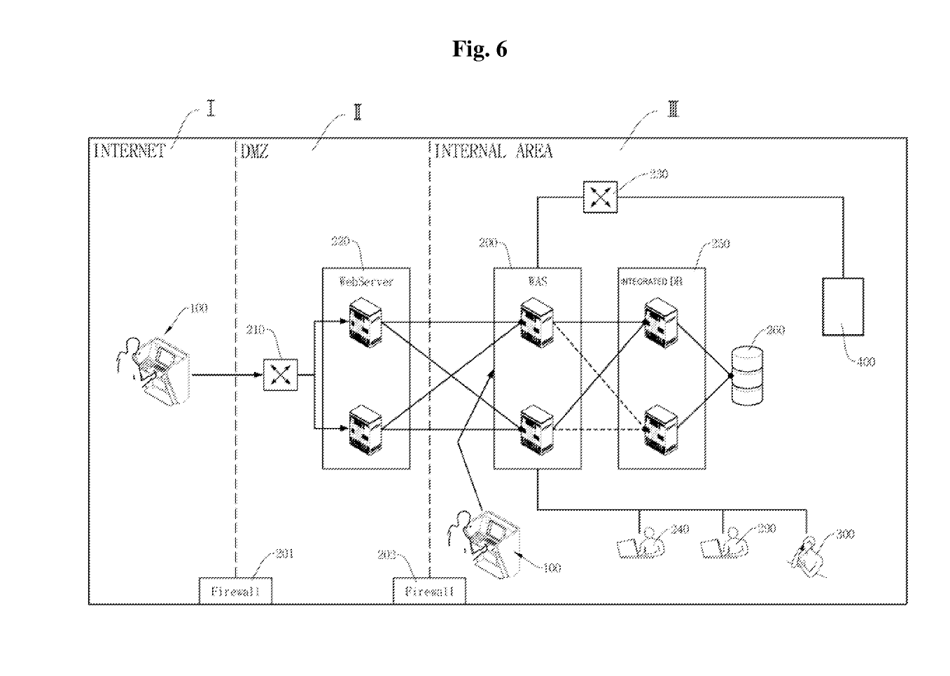

FIG. 6 is a view illustrating a system architecture according to an embodiment, which is more specifically realized than the conceptual network of FIG. 5. When a customer logs in through the networking terminal device 100, log-in request information is delivered in an HTTPS format to a web server 220 through an L4 switch 210. The L4 switch 210 decentralizes the load for a server and improves its speed. The information delivered to the web server 220 calls a corresponding service from a Web Application Server (WAS) of an insurance company.

Information mapped through the WAS 200 requests corresponding information to the Legacy 400 through an adaptor 230, and the Legacy 400 delivers information on a user of the networking terminal device 100 to the WAS 200 through a professional communication in an XML format or other various protocols in response to the requested information.

On the basis of the user confirmation information delivered to the WAS 200, the WAS 200 calls a video confirmation service from a client service of the counselor terminal 300. After it is confirmed that the called permission information of the counselor terminal 300, video/voice chatting permission information may be delivered to the networking terminal device 100 in response to the confirmation. The networking terminal device 100 receives the response information of the counselor terminal 300, and then performs an insurance payment request procedure according to predetermined procedures. The counselor terminal 300 confirms information and documents, which are transmitted in real time from the networking terminal device 100, and then, transmits complete information to the WAS 200. Then, the WAS 200 delivers complete mapped information to the Legacy 400 through an adaptor 230.

The information submitted from the networking terminal device 100 is stored in an integrated storage 260 through an integrated DB 250. Additionally, some or entire video communication contents on the networking terminal device 100 and the counselor terminal 300 may be stored in the integrated storage 260.

The integrated DB 250 stores mapping information and various data used in the system of the present invention, and the integrated storage 260 supports disk mirroring, backup and recovery, permanent storage and data search for permanent storage, data transfer from one storage device to another storage device, and data sharing between different servers on a network.

Additionally, a verifier terminal 240 for system verification and a customizing terminal 290 for system and site management may be included.

Moreover, a region I of FIG. 6 is a free internet region in an external of an insurance company, and a region III is an internal region of the insurance company. In order to access from the external internet region I to the internal network III of the insurance company, a DMZ area II, i.e., an internet service section secured by a firewall 201, is required. As shown in FIG. 6, the networking terminal device 100 may be in the internal network III, and this means that a physical space is a branch of an insurance company, and also a networking terminal device installed in a branch of an insurance company.

<A Third Aspect of the Present Invention>

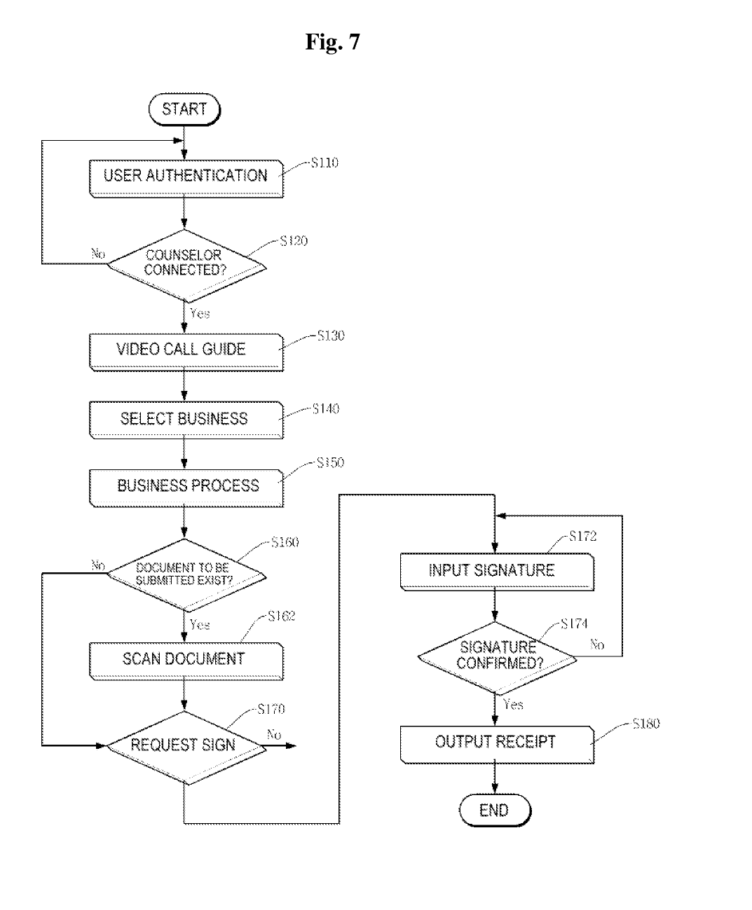

FIG. 7 is a schematic view illustrating an entire configuration of a supporting business process executed by an application element of a networking terminal device of the present invention. First, a user of the networking terminal device 100 inputs an ID and password, and performs a user authentication in operation S110. Once the user authentication is completed, an application server of an insurance company automatically switches a connection between a networking terminal device and a counselor terminal in operation S120.

Once the connection between a networking terminal device and a counselor terminal is tunneled, a real time guide by a video call starts in operation S130. As being guided in real time by a counselor, the user of the networking terminal device selects a business in operation S140.

Businesses that the networking terminal device supports may relate to an insurance claim for payment. Here, the businesses may include a business regarding a general insurance claim for payment, a business regarding an accident insurance claim for payment, and a business regarding customer information management. Once the networking terminal device selects a specific business, the selected business process is performed according to a predetermined procedure in operation S150.

The networking terminal device transmits an insurance claim request. Herein the insurance claim request includes an insurance payment, an insurance inquiry, a customer information inquiry, and a modification business. The reason is that various inquires and management businesses closely relate to an insurance payment business.

Of predetermined procedures, if document submission is required, a guide message may be outputted to the networking terminal device in operation S160. With a voice guide message transmitted from a counselor terminal, an input of the documents for submission may be displayed through a screen of the networking terminal device. At this point, a user of the networking terminal device inserts the documents for submission into a scanner for scanning in operation S162, so that the scanned documents may be immediately confirmed by a scan viewer at the counselor terminal side. If there is no scanning and inputting when document submission is required, a procedure may be terminated by the networking terminal device or the counselor terminal.

Once documents for submission are scanned, the scanned data are immediately confirmed in the counselor terminal, and are automatically stored as electronic files in an integrated storage of an insurance company system. Accordingly, in relation to an insurance claim for payment, typical efficiency of human and material of an insurance company, which are invested on electronic document generation businesses and storage businesses, may be greatly improved.

Next, as a predetermined procedure continues again, all application procedures are completed, a message for requesting an input of signature may be outputted to the networking terminal device in operation S170. In relation to an insurance claim procedure of general insurance payment, or accident insurance payment, if there is no procedure for requiring an input of signature, it means that the insurance claim procedures may be still in process or may be stopped by errors. The networking terminal device inputs a signature through a sign pad in operation S172, and the inputted signature is immediately confirmed through a screen of a counselor terminal. The signature is confirmed through the counselor terminal in operation S174, and if it is not inputted or inaccurate, the signature procedure resumes again. Once the signature confirmation is completed, a receipt is outputted by the receipt printer of the networking terminal device in operation S180, and then, the procedure is terminated.

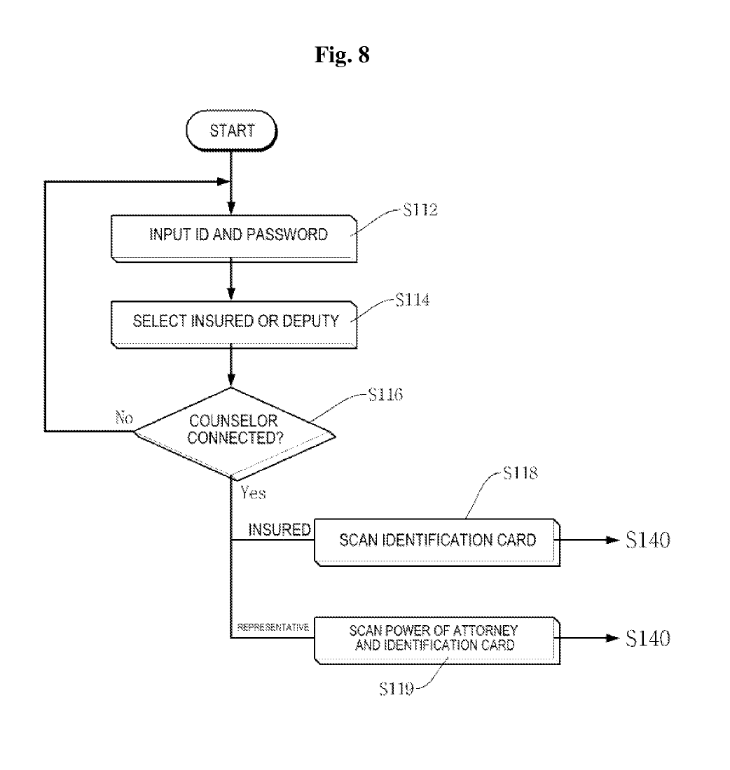

FIG. 8 is a view illustrating a user authentication in a real time supporting process on a business regarding an insurance claim for payment, which is executed by an application element of a networking terminal device of the present invention.

First, a user of the networking terminal device 100 inputs an ID and password, and performs a user authentication in operation S112. Then, a question on whether an application is made by the insured or a representative is displayed on the screen of the networking terminal device, and selecting one of them is required in operation S114. Then, an application server of an insurance company automatically switches a connection between a networking terminal device and a counselor terminal in operation S116. If not connected, a procedure starts again from the beginning. Once the connection between a networking terminal device and a counselor terminal is successful, the networking terminal device shares its screen with the counselor terminal Additionally, through an image captured by a camera in real time, the user's face of the networking terminal device may be displayed on the screen of the counselor terminal.

If “the insured” is selected in operation S114, the ID of the insured is scanned in operation S118, and if the “representative” is selected, the power of attorney and the ID of the representative are scanned in operation S119. The ID and the power of attorney are displayed on the screen of the counselor terminal through its scan document viewer, and a procedure proceeds only if the counselor terminal provides a final approval on user authentication. That is, the authentication of the processes of the present invention needs to be satisfied by both the networking terminal device and the counselor terminal.

Moreover, the authentication procedure in the networking terminal device, i.e., the authentication by the ID and password input, and the authentication confirmed by scanning and transmitting the authentication documents in real time, corresponds to an authentication procedure in an initial state of a supporting business process. The networking terminal device of the present invention further includes an authentication procedure in a final state that completes the supporting business process, which is the authenticated by the above described electronic signature or finger print.

<A Scenario of the Present Invention>

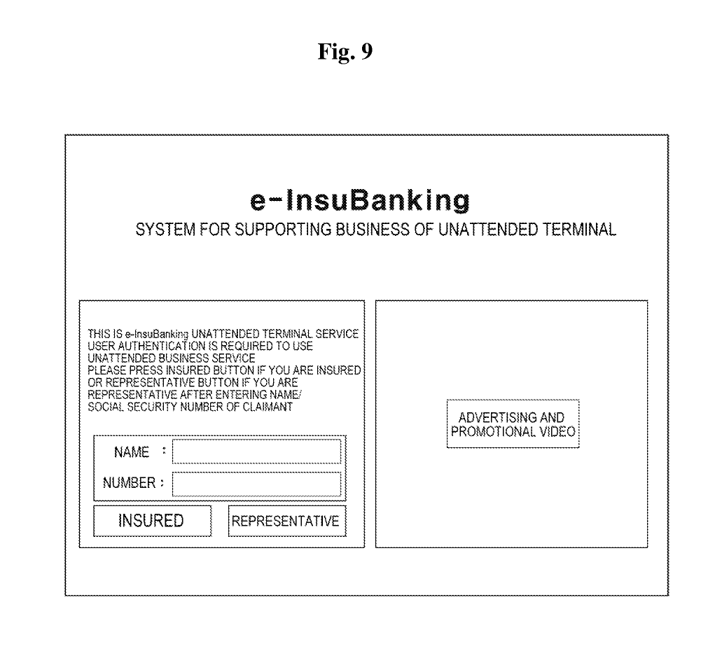

FIGS. 9 to 15 are views illustrating a scenario configuration of a supporting business displayed on a screen of the touch screen 170, which includes an application element of a networking terminal device 100 of the present invention.

FIG. 9 is a view illustrating an initial screen configuration example of the networking terminal device 100. A user interface for system login is provided at the left, through which a name and social security number are inputted. According to another embodiment, an original ID and PASSWORD of a user may be inputted. Additionally, an interface for selecting one of a claim procedure for the insured and a claim procedure for a representative may be provided. Moreover, an image may be displayed at the right. According to an embodiment, a promotional video of an insurance company, a commercial advertising image, or a public interest promotional image may be played on an image display area at the right.

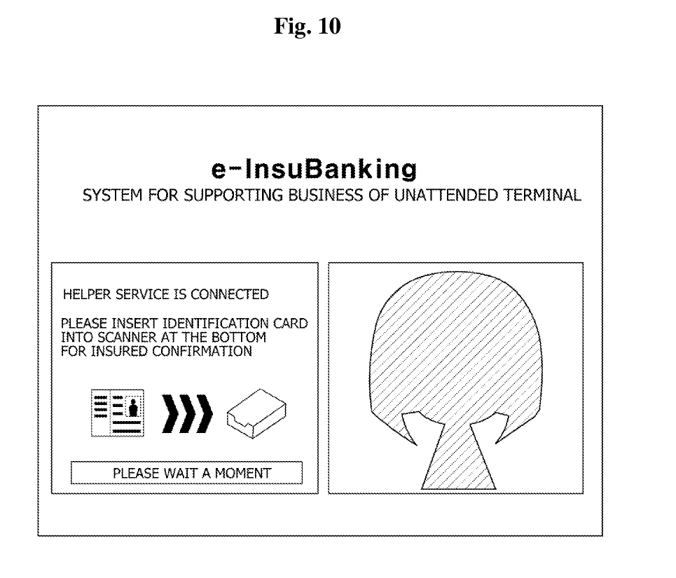

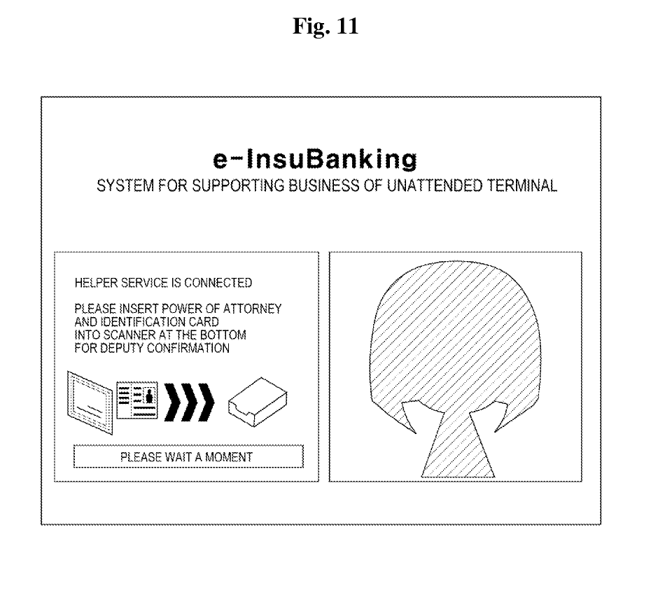

After login information is inputted, if the insured is selected, a notice “connecting” and a screen in connection are displayed on the image display area at the right. Then, once the connection is completed, an image of a user (i.e., a counselor) of a counselor terminal is displayed, so that a video guide may start. FIG. 10 and FIG. 11 have a similarity. If the insured is selected in FIG. 9, as shown in FIG. 10, it is instructed at the left in the screen to input the ID of the insured into a scanner of the networking terminal device. If the representative is selected in FIG. 9, as shown in FIG. 11, it is instructed at the left in the screen to input the power of attorney and the ID of the representative into the scanner of the networking terminal device.

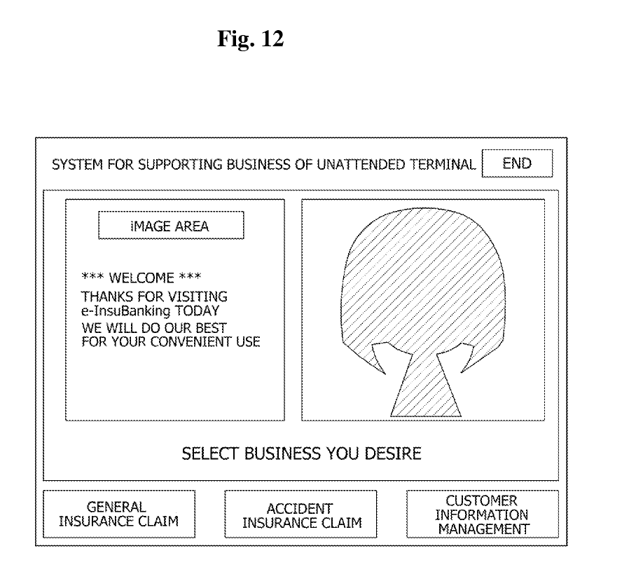

Once the ID of the insured or the power of attorney and the ID of the representative are scanned completely through the scanner of the networking terminal device, a counselor terminal confirms them in real time through a scan viewer. Once confirmation is completed, all authentication procedures end, and a real business supporting process starts as shown in FIG. 12.

The user image of the counselor terminal is continuously displayed on the image display area at the right of FIG. 12, and a real time voice guide is outputted. At this point, three business selection buttons for “general insurance claim”, “accident insurance claim”, and “customer information management” may be displayed on the screen of the networking terminal device. By selecting one of them, a predetermined real-time guide service continues. If the general insurance claim button is clicked, it moves to a general insurance claim menu, and if the accident insurance claim button is clicked, it moves to an accident insurance claim menu. If the customer information management button is clicked, it moves to a customer information management menu. If an end button is clicked, the system is terminated.

Each menu suggests customer information necessary for each procedure. Additionally each information includes detailed items. The items include a title, important dates, personal information, the amount, the interest, and account information. Various modification, edition, and additions are possible, which may be configured in advance during a system establishing stage.

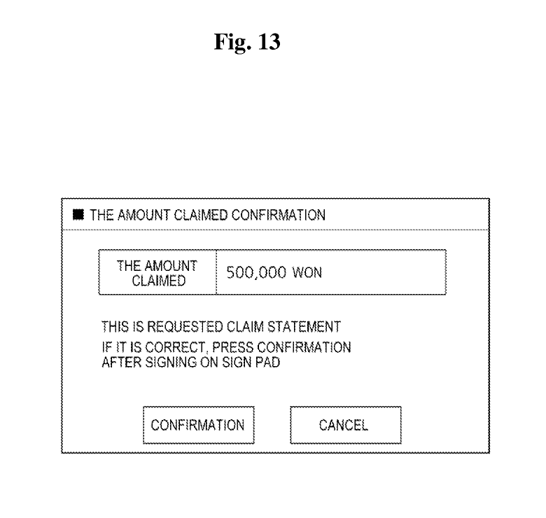

For example, after a general insurance claim procedure sequentially proceeds, if a customer claims the amount of 500,000 won at the last, a window for confirming the amount and requesting a signature may be pop-up on the screen of the networking terminal device, as shown in FIG. 13. When the user of the networking terminal device signs a signature on a sign pad, and clicks a confirmation button, the counselor terminal confirms the signature in real time, and accepts a general insurance claim.

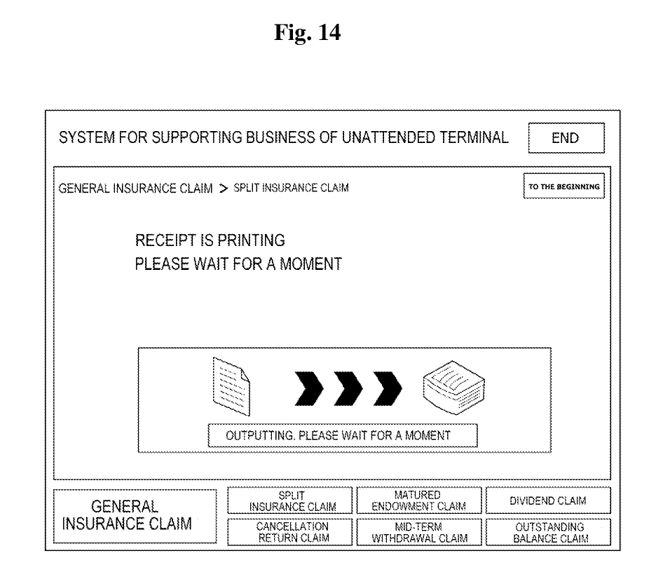

As shown in FIG. 14, a receipt output guide message is displayed on the screen of the networking terminal device, and a receipt is outputted through a receipt printer thereof.

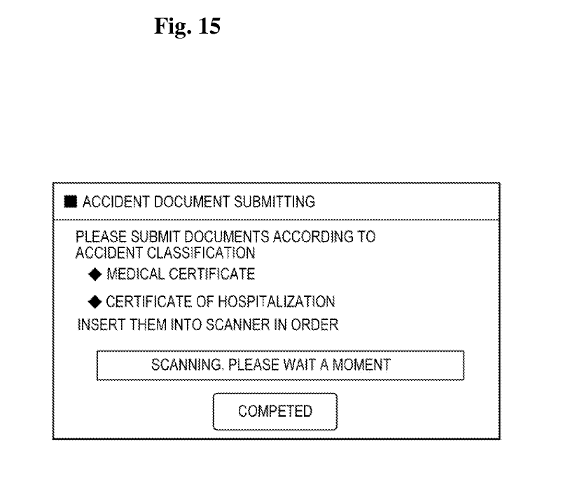

As shown in FIG. 12, when the networking terminal device selects an accident insurance claim, documentary evidence needs to be submitted after procedures such as a guide, an inquiry, and accident information input. For example, the documentary evidence includes a medical certificate, and a certificate of hospitalization. As shown in FIG. 15, a window for requiring submitting of documentary evidences is pop-up on the screen of the networking terminal device, and the documentary evidences are inserted into the scanner of the networking terminal device for scanning When scanning is completed and a confirmation procedure is performed in the counselor terminal, an insurance claim is completed after a procedure such as the signing of a signature of FIG. 13 and the outputting of a receipt of FIG. 14.

According to the scenario, the connection between the networking terminal device and the counselor terminal is continuously maintained, and a real-time guide is provided through a video communication and/or voice communication. Moreover, the screen of the networking terminal device may be remotely viewed through the screen of the counselor terminal, and the signature and document scan of the networking terminal device may be confirmed in real time in the counselor terminal, so that an unattended system for an insurance claim for payment may be realized.

Now, a scenario realized in a screen of a counselor terminal will be examined.

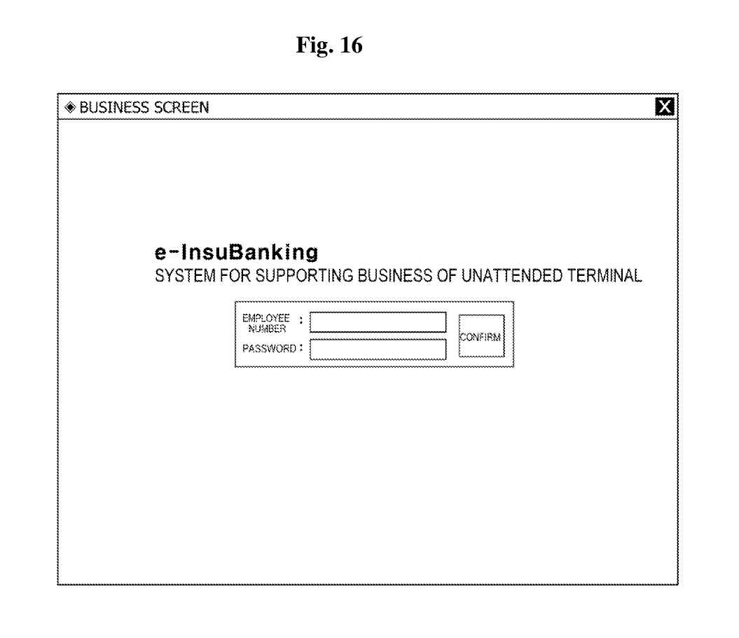

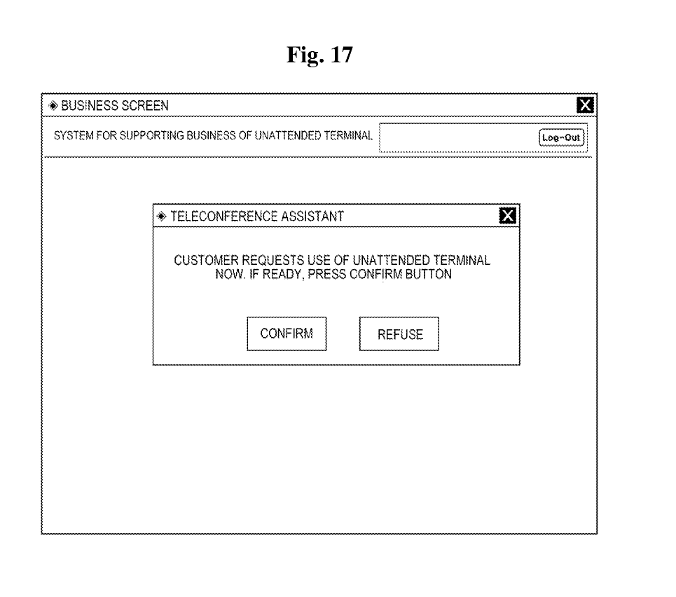

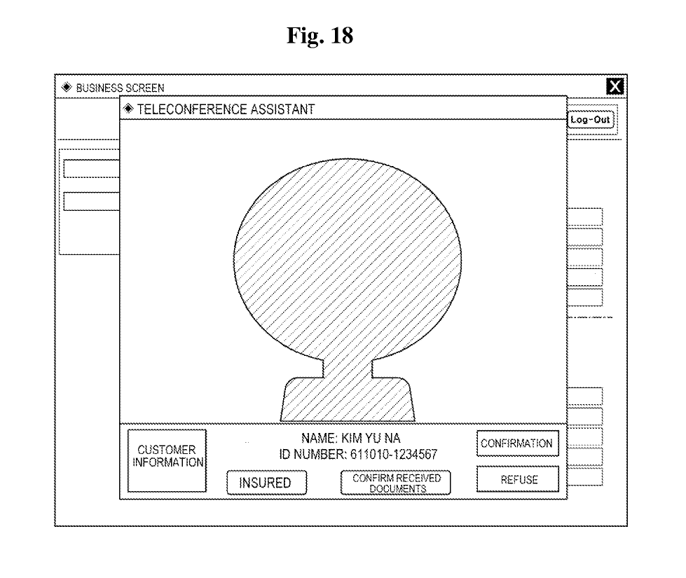

A user of the counselor terminal may log in by inputting an ID and password on an initial screen of FIG. 16. When an unattended terminal in a login state logs in a system for access, a system automatically switches to select a counselor terminal not being currently in counseling from a plurality of counselor terminals, and then, displays a message on a screen of a specific counselor terminal, as shown in FIG. 17. At this point, if the counselor terminal refuses (i.e., when not in a consulting preparation), another counselor terminal is automatically selected. Then, when a confirmation button is clicked, the user information of an unattended terminal is displayed as shown in FIG. 18.

A user image of the unattended terminal is displayed by a camera installed therein, and information on the user of the unattended terminal may be displayed using the login information. Additionally, a pop-up interface, which is related to whether the user of the unattended terminal is “the insured” or “a representative”, the installation position or serial number of the unattended terminal, and a scan document viewer, may be included.

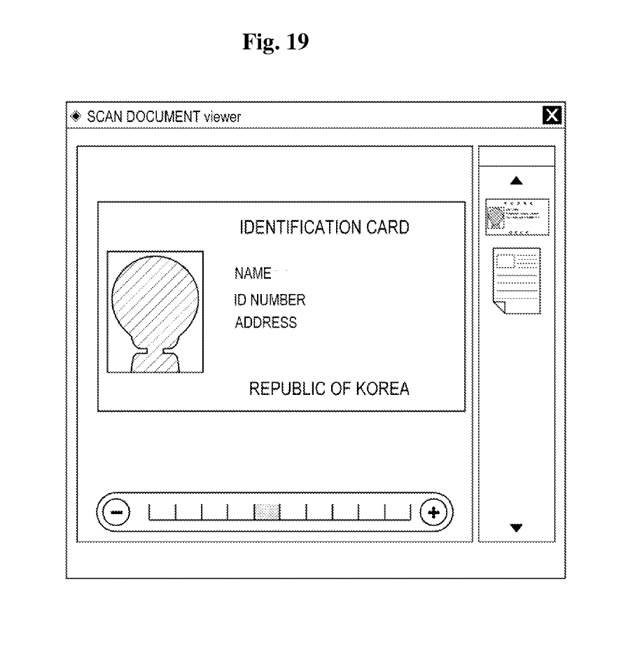

The counselor terminal confirms an identification (and a power of attorney) scanned by the unattended terminal through the scan document viewer, and for example, the image of the user confirmed by the scan document viewer is compared with a real-time captured image of the user sitting at the front of the unattended terminal. FIG. 19 is a view of a scan document viewer. The scan document viewer of FIG. 19 is pop-up on the screen of the counselor terminal. A documentary evidence such as a medical certificate scanned by the unattended terminal may be viewed through the scan document viewer of FIG. 19.

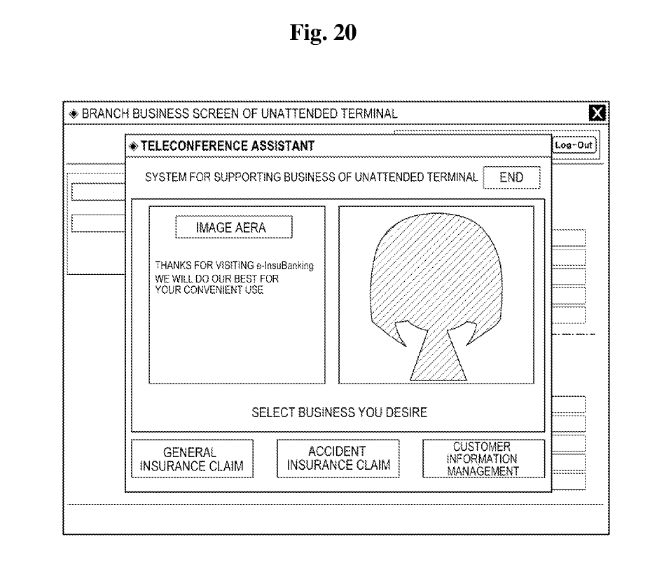

When the counselor terminal of FIG. 18 clicks a “confirmation” button, a remote supporting screen may be pop-up on the screen of the counselor terminal That is, the screen of the unattended terminal is displayed as it is on the screen of the counselor terminal. As shown in FIG. 20, the screen of the unattended terminal as shown in FIG. 13 is pop-up on the screen of the counselor terminal, so that the counselor terminal provides real-time guide and support as looking at the pop-up window.

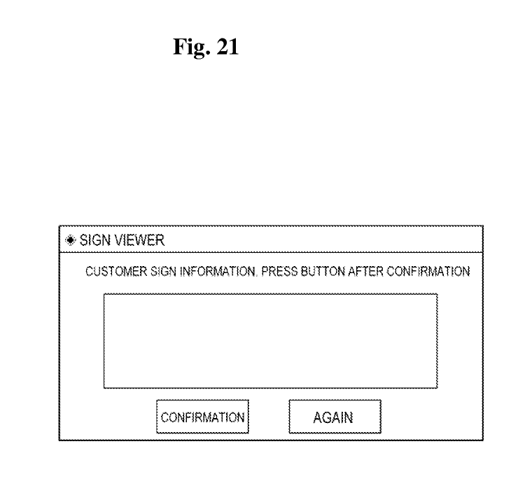

Additionally, when a signature is inputted through a sign pad of the unattended terminal, the sign viewer window of FIG. 21 is pop-up on the screen of the counselor terminal, so that it is verified whether the signature is correctly inputted or not.

Moreover, the protection scope of the present invention is not limited to the above explicitly described embodiments. Additionally, the protection scope of the present invention is not limited to the modification or replacement of the embodiments, which is obvious in the technical field that the present invention belongs.

1. A networking terminal device in a public space, which accesses a server in connection with a communication cable installed at the public space and includes a screen and an input unit, the networking terminal device comprising:
a scanning element for scanning a document and an identification card to generate an electronic file;
an authentication element for authenticating a user;
a real-time communication element accessing the server for transmitting a file, which is generated by the scanning element and/or the authentication element, to the server; and
an application element for executing a supporting business selected according to a predetermined process,
wherein the elements are embedded in a housing and operated according to the control of a control unit in the housing.

2. The networking terminal device of claim 1, further comprising a camera element for capturing an image of a user to generate image data in real time,
wherein
when the networking terminal device accesses the server and the server connects another terminal connected to the server with the networking terminal device in order to open 1:1 communication, the generated image data are transmitted to the other terminal connected to the server.

3. The networking terminal device of claim 2, wherein an image of a user of the other terminal is displayed in real time on a screen of the networking terminal device.

4. The networking terminal device of claim 1, wherein the housing comprises:
a front part having a standing structure and in which the screen is embedded;
an input unit guiding part in which the input unit is embedded, the input unit guiding part having a protruding structure formed by a portion of the front part sloping downward and bending forward; and
a side wing part for blocking the gaze of others looking at the screen,
wherein the scanning element is disposed at one side of the input unit guiding part.

5. The networking terminal device of claim 1, wherein, if the networking terminal device accesses the server and the server connects another terminal connected to the server with the networking terminal device in order to open 1:1 communication, the application element comprises a module for sharing an image displayed on the screen of the networking terminal device with the other terminal,

6. The networking terminal device of claim 1, wherein, when the networking terminal device accesses the server and the server connects another terminal connected to the server with the networking terminal device in order to open 1:1 communication, an image file of the document or identification card scanned by the scanning element is displayed in real time on a screen of the other terminal.

7. The networking terminal device of claim 1, wherein the authentication element performs an authentication through an ID and a password inputted using the input unit.

8. The networking terminal device of claim 1, wherein the authentication element comprises a sign pad; and
when the networking terminal device accesses the server and the server connects another terminal connected to the server with the networking terminal device in order to open 1:1 communication, an electronic signature signed on the sign pad is displayed in real time on a screen of the other terminal.

9. The networking terminal device of claim 1, wherein the authentication element comprises a finger print input unit.

10. The networking terminal device of claim 1, wherein a rolling printer is embedded in the front part of the housing in the networking terminal device; and
when a request transmission by the application element is completed, a receipt is printed through the printer according to the request transmission.

11. The networking terminal device of claim 1, wherein a supporting business executed by the application element of the networking terminal device comprises a business for transmitting an insurance payment request.

12. The networking terminal device of claim 1, wherein the public space in which the networking terminal device is located comprises an administration building of a country or local government.

13. The networking terminal device of claim 1, wherein the public space in which the networking terminal device is located comprises a convenient store, a hospital, or a bank.

14. A system for supporting an insurance business of an unattended terminal, the system comprising:
an application server of an insurance company;
P (P is an integer greater than 1) counselor terminals connected to an internal network of the application server of the insurance company; and
N (N is an integer greater than 1) customer-only unattended terminals being disposed in different remote physical spaces and being 1:1 mapped to the counselor terminals for communication,
wherein each of the customer-only unattended terminals comprises:
an element for a real-time video call and/or voice call with the counselor terminal;
an element for scanning a document that is to be transmitted to the counselor terminal; and
an application element programmed to process a predetermined insurance payment request process,
wherein an insurance payment request is transmitted to the counselor terminal in real time.

15. The system of claim 14, further comprising an integrated storage device connected to the counselor terminal at the application server of the insurance company,
wherein the integrated storage device automatically stores a file transmitted from the customer-only unattended terminal and a part or entire video call data of the counselor terminal and the customer-only unattended terminal.

16. The system of claim 14, wherein the counselor terminal comprises a remote supporting application; and
a displayed real-time screen of the customer-only unattended terminal is pop-up on a screen of the counselor terminal in order to allow the counselor terminal to remotely support an insurance payment request process while looking at the screen of the customer-only unattended terminal.

17. The system of claim 15, wherein the file transmitted from the customer-only unattended terminal comprises an identification card, a power of attorney, or a documentary evidence for insurance payment, which are generated as a scan file by a scanner.

18. The system of claim 14, wherein the application element performs a process for generating an insurance payment request through an input unit of the customer-only unattended terminal; and
the insurance payment request is one of a general insurance payment request, an accident insurance payment request, and a customer information management request.

19. A method of using a system for supporting an insurance business of an unattended terminal, the method comprising:
connecting a customer-only unattended terminal located in a different remote physical space to an insurance company server;
switching a plurality of counselor terminals by the insurance company server so as to tunnel a 1:1 communication channel between the customer-only unattended terminal and the counselor terminal;
scanning user authentication information by the customer-only unattended terminal;
confirming the scanned user authentication information by the counselor terminal;
performing an insurance payment request procedure while the customer-only unattended terminal receives a remote communication support of the counselor terminal in real time;
if submitting a documentary evidence is required, scanning and transmitting the documentary evidence by the customer-only unattended terminal; and
inputting an electronic signature by the customer-only unattended terminal and confirming the electronic signature by the counselor terminal.

20. The method of claim 19, further comprising, when the insurance supporting request procedure is completed, outputting a receipt through a receipt printer of the customer-only unattended terminal.

21. The method of claim 19, wherein an integrated storage device established in the insurance company server automatically stores a file transmitted from the customer-only unattended terminal and a part or entire video integration data of the counselor terminal and the customer-only unattended terminal.

22. The method of claim 19, further comprising sharing a screen of the customer-only unattended terminal with the counselor terminal.
